(19) United States
(12) Patent Application Publication
(10) Pub. No.: US 2026/0028768 A1
(43) Pub. Date: Jan. 29, 2026

(54) VISUAL INDICATOR OF CHANGED LUMINANCE AND CHROMATICITY STATUS OF A HIGH VISIBILITY GARMENT

(71) Applicant: Richard Nicholas Dul, Nottingham (GB)

(72) Inventor: Richard Nicholas Dul, Nottingham (GB)

(21) Appl. No.: 18/997,445

(22) PCT Filed: Mar. 9, 2023
(86) PCT No.: PCT/GB2023/000012

§ 371 Date: Jan. 21, 2025

(30) Foreign Application Priority Data
Jul. 21, 2022 (GB) 2210673.6

(51) Int. Cl. D06H 1/02

(52) U.S. Cl. CPC D06H 1/02; D10B 2401/20; D10B 2501/00

(57) ABSTRACT

The present invention is directed to a visual indicator of the luminance and chromaticity status of a garment comprising: a heat applied transfer, emblem or directly printed indicator which is an enduring ink applied onto hi-vis; high visibility fabric garment. A separate fading ink is also employed in the production of the visual indicator and used only to print certain parts of the visual indicator that are required to fade due to prolonged exposure to UV rays from the sun at a similar rate to that at which hi-vis fabrics which when compliant and when new have been found to fade. This fading action of these certain parts create a message or a change to wording, phrases, images, shapes or symbols in a design which provides an objective visual indicator of non-compliance or expiry of the garment.

### FIELD OF THE INVENTION

The present invention relates to hi-vis (high visibility) clothing which is worn in working environments of industries and service sectors.

### BACKGROUND

The use of hi-vis garments is common in industry as they are appointed under safety regulation to be worn in various sectors. Hi-vis clothing must comply inter alia with standards relating to luminance and chromaticity (both as new and in use) which vary slightly from country to country. Owing to the effect of UV rays from the sun, luminance and chromaticity compliance reduces over prolonged exposure to the point at which the clothing no longer meets these important safety levels. Short of regular testing of hi-vis garments in service, it is almost impossible for the wearer or provider to establish when the garment no longer meets the proscribed safety standard such as EN 20471 (UK & Europe), ANSI 107 (USA), AS/NZS 4602 Australia and New Zealand, for example and thus to withdraw and replace the safety clothing.

An example can be shown in patent AU201720C427 (KOUSHIK, PETER) which discloses a high-visibility garment for providing safety to a wearer in a hazardous environment. The garment includes a high-visibility portion which, when the garment is new, is of a first colour that is definable as having a first set of colour chromaticity coordinates and first 5 luminance factor that provide the aforesaid safety. The garment also includes a colour referencing means providing a substantially permanent reference of a second colour, the second colour being definable as having a second set of colour chromaticity coordinates and a second luminance factor, wherein the second colour represents a colour of decreased visibility, relative to the first colour, for indicating a need to retire the garment. The first and second sets of colours 10 chromaticity coordinates are respectively within and outside a related polygon in the CIE colour space for that colour that is compliant with a safety standard, and the second luminance factor is less than the first luminance factor but greater than or equal to a minimum allowable luminance factor prescribed by the safety standard for the respective colour.

This patent example AU2017200427 must be manufactured to replicate the fabric colour when, after exposure to UV, it has reached the level of noncompliance for that particular fabric (in respect of luminance and chromaticity). As a result, an indicator for every fabric and every colour must be produced following UV exposure of said fabrics to the point of non-compliance. Furthermore, the decision as to when the fabric colour closely matches that of the indicator is subjective. In addition, the Fade Shade indicator must be attached to the garment during the manufacturing process

The prior art therefore shows that there is a need for a more effective visual indicator of the luminance and chromaticity status of a garment which can be applied to any garment requiring a status indicator and providing a clear visual message to the wearer that the garment must be replaced.

It is an object of the present invention to provide an improved visual indicator that shows the hi-vis garment item is likely to have reached or exceeded the acceptable point in respect of luminance and chromaticity and is to be equally applicable to yellow, orange and red hi-vis fabrics and is easily applied to said fabrics; and to significantly aid compliance with hi-vis standards as aforementioned. This problem is solved and is provided by the present invention having inventive steps which include the development of an ink and the utilisation of that ink in a format capable of easy application and attachment to a garment at any time. Furthermore; the creation of a design or cesigns which provide a clear and non-subjective means of indicating the likelihood of non-compliance by incorporating inks which withstand exposure to UV and also the developed ink which does fade in a selected area of the visual indicator changing the reading and therefore the meaning of a message, by making a letter of that wording fade, or part of an image fade, as described heretofore.

### SUMMARY OF THE INVENTION

According to the present invention there is provided a visual indicator of the luminance and chromaticity status of a garment which is applied at garment manufacture, wholesale, retail or end user level as heat applied transfers and emblems or by directly printing onto hi-vis fabric. This is executed in a design which provides a visual indicator of non-compliance, displaying, for one example; the wording ‘Sun-Safe’. Essentially, high visibility PPE (Personal Protective Equipment) is only compliant in three fabric colours: yellow, orange and red and there are published standards which state the range of luminance of the fabric and this degrades over time either through repeated exposure to sunlight or repeated laundering. These are appointed under safety regulation to be worn in various sectors and the hi-vis clothing must comply with standards relating to luminance and chromaticity (both as new and in use) which vary slightly from country to country. Owing to the effect of UV rays from the sun, luminance and chromaticity compliance reduces over prolonged exposure to the point at which the clothing no longer meets these important safety levels, as established. To solve this problem a separate ink is provided and used in the production of the visual indicator which fades when exposed to UV light at a similar rate to that of hi-vis fabrics, which when compliant when new have been found to fade. The said separate fading ink is employed in the production of the visual indicators in the form of heat applied transfers and emblems or by directly printing onto the hi-vis fabric in a design which provides a visual indicator of non-compliance. This separate ink is only applied to areas of the visual indicator which are required to degrade on exposure to light to display a message to indicate when the fabric no longer meets the required standards in terms of luminance and should be replaced. For one example; the printed transfer has the text “Sun-Safe” when new but over time, the “S” fades to reveal the message “un-Safe” to indicate that the garment should now be replaced. The separate developed ink provides the ability for the letter ‘S’ to fade owing to the inks ingredient compilation and is used to print this letter, while the remaining letters and any pattern of the indicator transfer remain intact and unfaded, due to the ink on the remaining areas being of a durable ink type which withstands exposure to UV and repeated washing. The fading ink can also be applied to other parts of the visual indicator, such as non-language specific images, shapes or symbols which are located near the wording, for example a more universally recognisable ‘Tick’ to indicate a positive standard indication to the emblem also fades along with the aforementioned ‘S’ to confirm that the garment requires replacement.

As an industry product provider, a manufacturer of garments inter alia may use this as a way of demonstrating conformity of their product with the required norms and standards and also as a prompt to trigger replacement when the garment no longer meets the normal standards. It is unlikely that a user would wish to wear a piece of safety clothing that says “un-Safe” and therefore novelty is prominent and combined with the safety standards as a solution. By using a heat applied transfer, emblem or direct to fabric print, the visual indicator can be easily attached to the garment at manufacture, wholesale, retail or even end user level. Furthermore, the indicator is of a design which provides an objective rather than subjective indication of the need to withdraw/replace.

The message that is displayed when the indicator transfer fades may vary and the wording of ‘Sun-Safe’ is not limiting and it is to be understood that the phraseology and terminology employed herein are for the purpose of description and should not be regarded as limiting. For example; other wording which can be used include the visual indicator messages of ‘Call to Arms’ “Replace or Withdraw” for example; to indicate when the garment should be replaced.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new and improved visual indicator of luminance and chromaticity status of a garment which has all the advantages of the prior art garment wear indicators and none of the disadvantages.

It is another object of the present invention to provide a new visual indicator of luminance and chromaticity status of a garment which may be easily and efficiently manufactured and marketed.

It is a further object of the present invention to provide a new and improved visual indicator of luminance and chromaticity status of a garment which is of durable and reliable construction.

An even further object of the present invention is to provide a new and improved visual indicator of luminance and chromaticity status of a garment which is susceptible of a low cost of manufacture with regard to both materials and labour and which accordingly is then susceptible of low prices of sale to the consuming public, thereby making such a product available to the buying public.

Still yet another object of the present invention is to provide a new and improved visual indicator of luminance and chromaticity status of a garment which provides in the apparatuses and methods of the prior art some of the advantages thereof, while simultaneously overcoming some of the disadvantages normally associated therewith.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and detailed descriptive matter in which there is illustrated preferred embodiments of the invention.

### BRIEF DESCRIPTION OF FIGURES

FIG. 1 shows a front view of the visual indicator of luminance and chromaticity status of a garment displaying the full ‘SUN-SAFE’ message when first applied to the garment.

FIG. 2 shows a front view of the visual indicator of luminance and chromaticity status of a garment displaying the ‘UN-SAFE’ message indicating that the garment on which it is applied should be replaced.

### DETAILED DESCRIPTION OF FIGURES

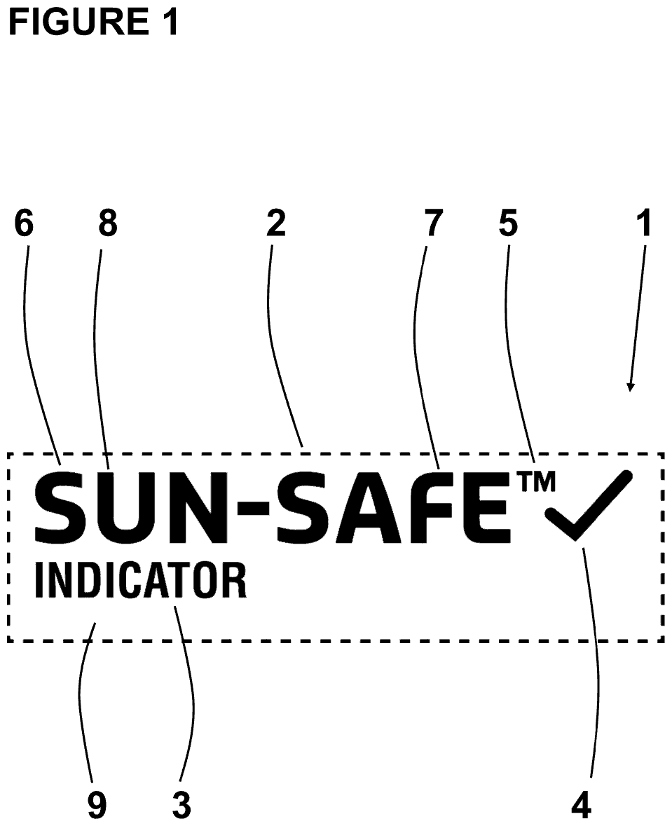

A typical embodiment of the visual indicator of luminance and chromaticity status of a garment is shown in FIG. 1 wherein the inks in this particular example are printed as a heat applied transfer 2 which has wording printed onto its surface 9 using ink which is of a durable type which withstands exposure to UV and repeated washing.

The inks can also be alternatively printed onto any other emblems or by directly printing onto the hi-vis fabric.

The word ‘SAFE’ 7, lettering TM, 5 and the word INDICATOR 3 are printed using the durable ink and the letters and hyphen ‘un-’ 8 are also printed using the durable ink, to ensure that their ink remains readable and long lasting.

The separate fading ink is applied to create the printed letter ‘S’ 6, to complete the word ‘Sun’ along with the durable ink letters and hyphen ‘un-’ 8.

A tick symbol 4 is also printed using the separate fading ink which is located to the wording SUN-SAFE TM.

Therefore, the letter ‘S’ 6 and the tick symbol 4 are the only two parts of the complete heat applied transfer logo, the application in this one example, which will fade when exposed to UV light at a similar rate to that of hi-vis fabrics.

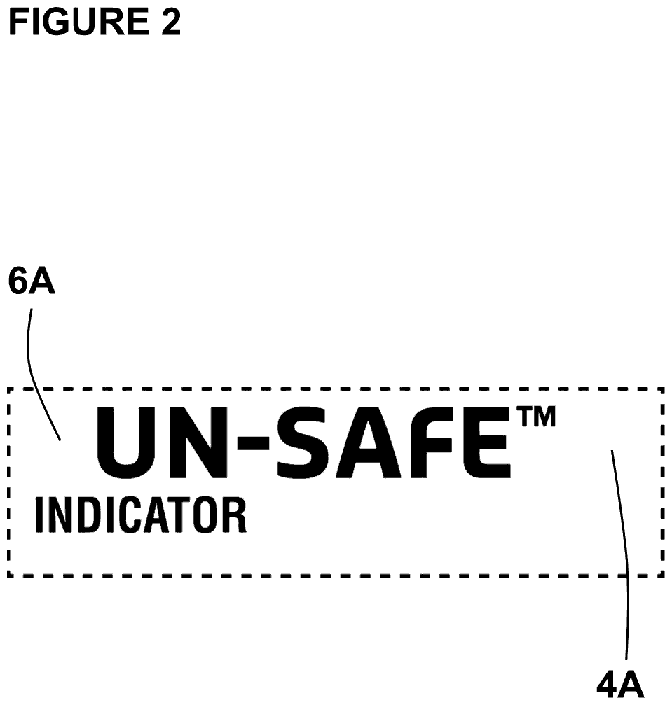

FIG. 2 shows these two examples, the letter ‘S’ 6A and the tick symbol 4A faded away from view as they would appear after the aforementioned exposure to UV light, indicating and warning the wearer that the garment is no longer fit for purpose or safe to wear and should be replaced.

1) A visual indicator of the luminance and chromaticity status of a garment comprising; a heat applied transfer, emblem or directly printed indicator which use an enduring ink to be applied onto hi-vis; high visibility fabric garments, having a separate fading ink which is also employed in the production of the visual indicator and used only to print on certain parts of the visual indicator that, in use, are required to fade due to prolonged exposure to UV rays from the sun, at a similar rate to that at which hi-vis fabrics have been found to fade; creating a message or a change to wording, phrases, images, shapes or symbols in a design which provides an objective visual indicator of non-compliance or expiry of the garment onto which it is applied.

2) A visual indicator of luminance and chromaticity status of a garment according to claim 1 wherein the visual indicator is equally applicable to yellow, orange and red hi-vis fabrics.

3) A visual indicator of luminance and chromaticity status of a garment according to claim 1 wherein the remaining parts of the visual indicator transfer, emblem or directly printed indicator not printed using the separate fading ink remain intact and unfaded due to them being printed with an enduring durable ink.

4) A visual indicator of luminance and chromaticity status of a garment according to claim 1 wherein at least one or more letters, wording, phrases, images, shapes or symbols used in a message on a visual indicator fade.

5) A visual indicator of luminance and chromaticity status of a garment according to claim 4 wherein a faded letter on the visual indicator forms a new word due to the remaining unfaded letters of the original word spelling a different word.

6) A visual indicator of luminance and chromaticity status of a garment according to claim 5 wherein the fading of at least one or more letters, wording, phrases, images, shapes or symbols on the visual indicator changes the positive compliance status of a garment to a negative status.

7) A visual indicator of luminance and chromaticity status of a garment according to claim 6 wherein fading letters or symbols are not printed on top of other dry inks.

8) A visual indicator of luminance and chromaticity status of a garment according to any preceding claim wherein a visual indicator on a hi-vis garment is a clear and non-subjective means of indicating the likelihood of non-compliance of a garment by incorporating inks which withstand exposure to UV and repeated laundering and the further separate fading ink which does fade when exposed to UV light but not to washing.
